(19) United States
(12) Patent Application Publication
(10) Pub. No.: US 2004/0128648 A1
(43) Pub. Date: Jul. 1, 2004

(54) Face correlation between computer aided design models

(76) Inventors: Ari Rappoport, Jerusalem (IL); Steven Spitz, Jerusalem (IL); Michal Etzion, Jerusalem (IL)

Correspondence Address: FISH & RICHARDSON, PC, 12390 EL CAMINO REAL, SAN DIEGO, CA, 92130-2081, US

(21) Appl. No.: 10/363,184

(22) PCT Filed: Aug. 30, 2001
(86) PCT No.: PCT/US01/27198

(51) Int. Cl. G06F 9/44

(52) U.S. Cl. 717/105; 717/113; 717/121

(57) ABSTRACT

Computer implemented techniques for correlating faces between source (104) and target (108) data models in computer aided design (CAD) systems are provided. The techniques can involve computer software, hardware, and data structures. According to one embodiment, a technique involves selecting a point (120) in the source data model (104) that is interior to at least one source face (106). Next, a normal (124) is computed based on the interior point (120) and the source face (106). A set of target faces (132) is identified that contain the interior point (120), then a target normal (138) to the interior point (120) is computed with respect to a target face (146) in the set of target faces (132). The target normal (140) is compared to the source normal (124). If they match, then the source and target faces can be correlated. Additional steps include collecting other edge-connected target faces, using the first selected target face (146) as a base. As a result, the source face(s) (112) can be matched with one or more target faces (148), thereby allowing operations involving the source face (112) to be correlated to the target face (148).

### CROSS-REFERENCE TO RELATED APPLICATIONS

This application is related to co-pending U.S. patent application Ser. No. 09/655,547, and PCT International Application No. PCT/IB00/01355, both filed 6 Sep. 2000, and both entitled “METHOD AND APPARATUS FOR EDGE CORRELATION BETWEEN DESIGN OBJECTS”. This application is also related to U.S. Provisional Application Serial No. 60/297,014, filed 8 Jun. 2001, and PCT International Application No. PCT/US01/______, filed on the same day herewith, and both entitled “BOUNDARY REPRESENTATION PER FEATURE METHODS AND SYSTEMS”. Priority is claimed to all four applications and all four applications are incorporated herein by reference in their entirety where permissible under applicable patent law, treaty or agreement.

### BACKGROUND

1. Field of the Invention

This application concerns computer aided design systems, and more particularly methods and systems for correlating faces between computer aided design models.

2. Background Information

When exchanging data between different types of computer aided design (hereinafter “CAD”) system, it is convenient to export the source data object, which is a collection of features, in the source CAD system as a boundary representation and import the boundary representation into the target CAD system.

In practice, however, importing the boundary representation into the target CAD system creates problems, in particular in parametric feature based design (hereinafter “PFBD”) systems. A parametric feature based design system uses linguistic data structures, coupled with substitutable parameters, as the underlying source code for the data objects. This is as opposed to an explicit geometry system, where abstractions of various shapes are not possible in a linguistic data structure. The advantage of using a PFBD system is that the linguistic abstraction of the represented mechanical (or three-dimensional) object can be easily modified without disrupting the overall design. However, when a boundary representation is used to represent the linguistic data structure, the inherent value of PFBD is lost—the multitude of features used to create the source object are merged into a single boundary representation.

Beyond losing the linguistic elegance, what can also be lost is the ability to easily identify edges, and more particularly faces in the imported data object.

### SUMMARY OF THE INVENTION

Computer implemented techniques for correlating faces between source and target data models in computer aided design (CAD) systems are provided. The techniques can involve computer software, hardware and data structures.

According to one embodiment, the techniques involve selecting a point in the source data model that is interior to at least one source face. Next, a normal is computed based on the interior point and the source face. A set of target faces is identified that contain the interior point, then a target normal to the interior point is computed with respect to a target face in the set of target faces. The target normal is compared to the source normal, and if they match, then the source and target faces can be correlated. Additional steps include collecting other edge connected target faces, using the first selected target face as a base.

According to another embodiment, the techniques include a computer aided design system having access to a source data model and a target data model. The system generally comprises at least three memory areas. A source memory area is configured to hold information concerning faces, edges, at least one interior point, and an interior point normal, all corresponding to the source data model. A target memory area is configured to hold concerning edges, faces, and target normals, each target normal matching face in the target memory area, all corresponding to the target data model. A third memory area comprises computer program code. The computer program code is configured to cause a processor to correlate faces from the source memory area to faces from the target memory area, through one or more edges, points, and computations relative to data stored in the respective memory areas.

In one such embodiment, at least a portion of the source data model is placed in a source memory area, and at least a portion of the target data model is placed in a target memory area. A processor, having access to face correlation program code, maintains a list of source faces, a list of source edges, and computes an interior point and normal to at least one of the source faces. The processor further maintains a list of target edges, a list of target faces, and a list of corresponding target face normals. The interior point normal is compared against the target face normals, and target faces not parallel to the interior point normal are eliminated from the target face list. In one technique, one of the non-eliminated target faces is used as a starting point from which to build an edge-connected set of faces within a set of boundary edges. A list of such edges is created by the processor and used to correlate the source faces with the corresponding target faces.

According to yet another embodiment, the techniques include a computer readable data structure. The structure includes a parametric representation of a feature, the feature having been extracted and interpreted from a source CAD system in a format other than the feature's native format. The structure further includes an unparameterized representation of a feature, the unparameterized representation of the feature being a boundary representation and supplementing the parametric representation of the feature. Furthermore, the structure includes a data dictionary configured to maintain face correlation information that is used to match one or more faces from a source CAD system to one or more faces in a target CAD system.

These and other embodiments,.features, and techniques are described in detail below.

### BRIEF DESCRIPTION OF THE DRAWINGS

FIG. 1 is an operational overview of the face correlation methods and system.

FIG. 2 is a flowchart depicting a computer implemented face correlation method.

FIGS. 3A-D depict conceptual views of various point selection algorithms.

FIG. 4 depicts an operational overview of CAD data exchange employing boundary representation per feature.

FIGS. 5A-B are diagrams of source and target CAD data models.

FIGS. 6A-D and 7-12 depict edge selection techniques. In particular: FIG. 6A is a perspective view of a source object and an edge; FIG. 6B is a perspective view of the source object with a feature applied to the edge; FIG. 6C is a perspective view of a target object and an edge; FIG. 6D is a perspective view of the target object with the feature applied to the edge; and FIG. 7 is an operational overview of a computer implemented edge selection process. FIG. 8 is a flowchart depicting a method for detecting whether two edges overlap. FIG. 9 is a diagram of a source edge and a series of target edge candidates that illustrates a technique for determining regions. FIG. 10 is a flowchart depicting an edge containment algorithm. FIG. 11 is a flowchart depicting a method for detecting an initial edge. FIG. 12 is a flowchart depicting a chain extension algorithm.

### DETAILED DESCRIPTION OF THE PREFERRED EMBODIMENTS

The ability to identify faces in a computer implemented geometric entity created in a CAD system has many advantages. This is particularly true in a CAD system where correlation between differing data models is desired for purposes such as co-editing or design collaboration, which is often desired by engineers and other technical persons when trying to design or manufacture physical objects used in commerce.

Perhaps the most significant advantage is that operations are occasionally performed on a face, or by reference to a face, and if the system does not know where the face is, then the operation cannot be performed. For instance, a face may have its geometry manipulated by a smoothing operation, or another object can be attached or intersected with the face.

To make the problem more concrete, we begin this detailed description by setting up an exemplary working environment: a design engineer at a design facility has designed a three dimensional object using a first CAD system. This design will be manufactured under the supervision of a manufacturing engineer at a manufacturing facility who uses a second, and normally incompatible CAD system. Because the data models between the CAD systems are not necessarily compatible, the two engineers must find a way to share design models. Moreover, since the manufacturing process may involve steps or concerns not anticipated by the design engineer, the manufacturing engineer desires to add, delete or modify features in the design engineer's CAD data model using her differing CAD system. Assuming there exists a way to exchange CAD data models between the differing CAD systems, there is also needed a way to correlate faces between the differing CAD data models so that operations on or analysis of a particular face can be performed.

The face correlation methods and systems described below are designed to determine a minimal collection of topological entities in a target boundary representation (hereinafter “brep”) that cover a topological entity in a source topological entity. This minimal collection of topological entities can then be used for identification and correlation purposes to perform additional operations or analysis on the target CAD data model that are performed on the source CAD data model.

### Operational Overview of Face Correlation

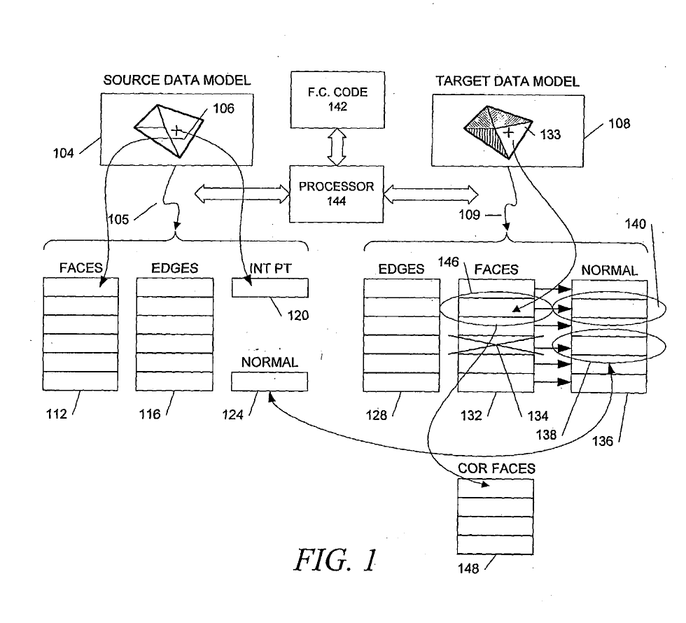

One embodiment of face selection is show in FIG. 1, which is an operational overview of the methods and systems. We begin with a source data model 104 and a target data model 108. The source data model 104 can be a parametric data model, while the target data model 108 is typically a boundary representation (also called a brep). Both the source data model 104 and the target data model 108 depict geometric shapes, which are illustrative only of a particular set of data objects and not illustrative of all particular scenarios in which the techniques described below have utility. One or more processors 144 have access to a memory (called here “source memory 105”) storing at least a portion of the source data model 104, and a memory (called here “target memory 109”) storing at least a portion of the target data model 108. These respective memory areas (105 and 109) can also store the various computer readable data structures described below.

In order to perform the techniques described herein, the processor(s) 144 has access to a computer readable medium, or program code, that is used to cause the processor(s) 144 to manipulate the data information stored in memory and perform computations thereon. Prior to execution of the program code, it is typically read from a persistent memory device, such a hard-disk, and placed in an execution memory area. Face selection code 142 is shown in such a state, where the program code (or at least a portion of the program code) is directly accessible by the processor(s) 144.

The source faces and edges of the source data model 104, as well as the brep of the target data model 108 are passed to the face correlation system. A list of source faces 112 is maintained, as well as a list of the source edges 116, preferably taken directly from the source data model 104. From the target data model 108, edges of the target topological entity are identified or correlated between the source data model 104 and the target brep, preferably using the edge correlation techniques described above. A list of target edges 128 is created.

Next, a point interior to one of the source faces 112 is computed and identified as interior point 120. Various techniques for computing the interior point 120 are discussed below. A normal to the interior point, with respect to the source face, is computed and stored as interior point normal 124.

The interior point 120 is used as a basis for selecting faces in the target data model 108. Here, faces are selected that contain the interior point 120. These faces are stored in target face list 132. In many cases, only one face will be identified that contains the interior point 120, but in some cases, for instance where interior point 120 lies on a vertex or edge, more than one face may be identified. A normal to the interior point 120, with respect to each target face 132 identified as including the interior point is computed and stored in target face normal 136, which is linked to the corresponding face in target face list 132.

Next, the interior point normal 124 is compared against each normal in the target face normal list 136—for example target normal 138 is compared to interior point normal 124. Each target face 132 where the corresponding target normal is not parallel to the interior point normal 124 is removed from the target face list 132—for example target face 134, assuming target normal 138 was not parallel to interior point normal 124. The result, that is the remainder of the faces in the target face list 132, is the carrier for the source faces from the source data model 104 and can be returned. However, if more than a carrier is needed, then adjacent faces in the target data model 108 are traversed through edge-connected faces (for example, using the target edge list 128—that is using those edges not being boundary edges) until all of the target faces covering the source faces are identified.

For instance, if target face 133 is placed in the target face list 132, in location 146, it can be identified as the starting target face from which to collect edge-connected faces. Target face 133 can be placed in a correlated faces list 148, which can be maintained in a data dictionary. The faces in target brep 108 with line fill patterns are the edge-connected faces, and these faces, which are all bounded by the heavy boundary edge surrounding the four faces in the target brep 108 will fill the remainder of the correlated faces list. The correlated faces list 148 will correlate the input source faces with the corresponding output target faces.

Detailed descriptions of the inventive face correlation methods and systems are set forth below reference to accompanying drawing sheets, and with particularity at the section entitled “FACE CORRELATION”. First, however, we present a foundation for understanding CAD data exchange, which is the environment in which the methods and systems of face correlation are preferably employed, as well as details for edge selections techniques, which compliment the face correlation techniques.

### Computer Aided Design Data Exchange

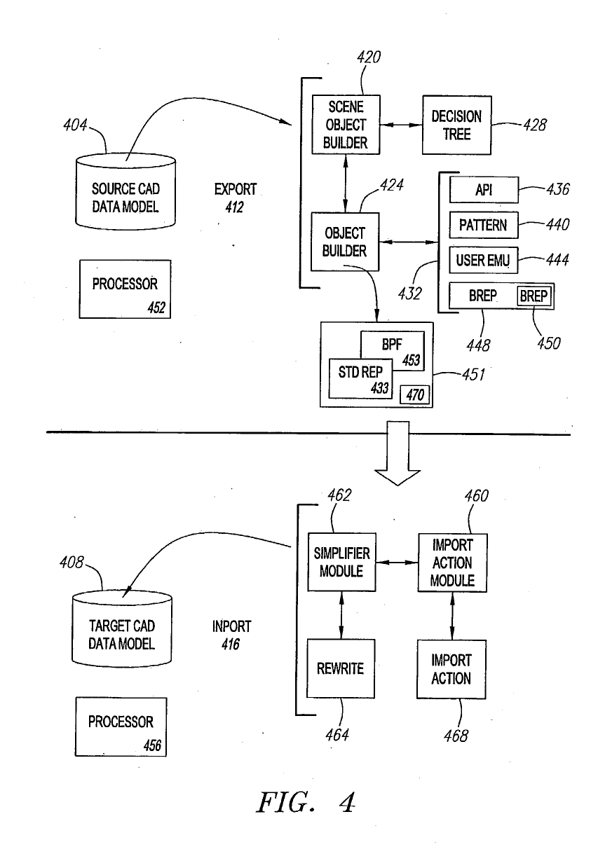

Turning to FIG. 4, it is a flowchart depicting a scenario under which CAD data exchange and complimentary boundary representation per feature (“BPF”) methods and systems can be employed.

According to one embodiment, the primary components of the data exchange system are a source CAD data model 404, a target CAD data model 408, and one or more processors (e.g. processors 452 and 456), and computer software product (configured to implement the functionality and/or steps described below). An export process 412 operates, by way of computer software product executed on processor 452, on the source CAD data model 404 to extract the features from the model 404. In a complimentary fashion, an import process 416 operates through processor 456 on the exported data model 451 (also called a universal product representation or “UPR”) from the export process 412 to input the UPR 451 in a representative fashion into the target CAD data model 408. It is noted that the UPR 451 from the export process 412, and the input to the import process 416 can be transitive in nature or persistent.

The export process 412 is depicted as a series of functional blocks. Each bock can comprise sequences of computer program code that is divisible from the other blocks. Block 420 is the scene object builder, which calls one or more object builders 424. The object builders 424 construct the elements of the data model from a feature tree. For each element identified from the scene object builder 420, a decision tree 428 is used to locate the appropriate object builder 424 to call. The object builders 424 perform iterative export methodologies 432 in an attempt to create the element.

According to one embodiment, the export methodologies include an application programming interface mode 436, where an API in the source CAD system is used to create the element, a pattern matching mode 440, where recognized operations from the source CAD data model 404 are mapped to corresponding operations in another data model or intermediate model. The export methodologies can further include a user emulation mode 444, where user emulation techniques are used to emulate the actions of an actual CAD user in a creation, selection, or export process, as well as examining data sent to a display, and using pull-down menus generated for the display, and a boundary representation mode 448. The boundary representation mode 448 further includes a boundary representation on a feature-by-feature basis (BPF module 450).

Each export methodology compliments the others. For instance, when using the API, user emulation may be necessary. Furthermore, we can export a BPF even if the API, pattern matching, user emulation, or any combination of the above are successful in creating a parameterized representation. Likewise we can, instead or further, export an entire brep.

The data result of the export process 412 is a computer readable data structure UPR 451, which comprises a standard parametric representation 433 of a feature (for example a parametric representation of the feature in a non-native format), and an unparameterized representation 453 of the feature (for example a brep). According to one embodiment, multiple breps for a single feature are included in the UPR 451, each being created by a unique algorithm.

Before moving on, it is noted that the UPR 451 can include a plurality of features, each feature having a parameterized representations 433 and an unparameterized representations 453. Corresponding (or “matching”) representations 433 and 453 can be logically or physically associated (or “attached”) to each other. For instance, a data dictionary in the UPR, or corresponding thereto, can maintain the appropriate associations and, for example, specify the mode or operation(s) by which the representations were created. Alternatively, the UPR components can by physically arranged so that their relationship is implicit or called out by some other identifying data. According to one embodiment, the UPR includes face correlation data, for instance in a data dictionary 470, that correlates one or more target faces to one or more source faces—for example, the correlated faces list 148 depicted in FIG. 1 can be represented in the data dictionary 470.

Once the source CAD data model 404 is exported, the import process 416 takes over. Here again, the blocks can be represented physically as multiple blocks of computer program code, which are executed by a processor, such as processor 456. The processor 456 is typically associated with the target CAD system.

Continuing with the data flow through the system, the UPR 451 from the export process 412 is processed by the import software 416, which operates one or more processors as follows: Each of the features from the export 412 is looped over in some order. This order can be user specified, data structure specified (for instance from the data model in the source CAD system), CAD system specific, or specified by another means. For each feature, an import action module 460 is called. The import action module 460 comprises import actions 468, which are procedures that import particular features (the subject feature) into the particular target system 408.

If an import action 468 does not exist or fails to execute successfully, then a simplifier module 462 is invoked. The simplifier module 462 calls a rewrite function 464. The rewrite function 464 rewrites the feature as a different feature or a set of features. After the rewrite function 464 is completed, then the import action module 460 again attempts an import action 468. (It is noted that additional details of the methods and techniques described in this section are set forth in U.S. Provisional Application No. 60/297,014, filed 8 Jun. 2001, and PCT International Application No. PCT/IUS01/______, filed on the same day herewith, both entitled “BOUNDARY REPRESENTATION PER FEATURE METHODS AND SYSTEMS”, both of which are incorporated herein by reference in their entirety above.)

If the rewrite function 464 and second import action 468 are not successful, then the simplifier 462 rewrites the feature to an orphan feature. If the orphan feature has a brep (BPF), then the simplifier 462 succeeds, otherwise it fails. (It is noted that for simplicity, only two rewrite 464 and import 468 actions are described. In fact, several iterations of the two can be attempted before the orphan feature is created.)

For instance, if a brep for a feature is a single skin, then the simplifier 462 can re-write the feature as an orphan-sew operation. On the other hand, if the brep for a feature comprises multiple skins, then the simplifier 462 can re-write the feature as a series of orphan-sew operations (a “multi-sew” operation). Further still, if the brep is a single solid, then hybrid re-writes can be implemented by the simplifier, such as an orphan-create, add, cut or intersect.

### Edge Selection

According to an embodiment, the abstraction of a complex freeform surface is treated as a series of bounded edges. Together the bounded edges can define the surface, or face of the CAD object.

As is mentioned above, selection of the face involves breaking the surface into its constituent members, the members including a plurality of edges. Thus, a presently preferred embodiment includes an edge correlation process. The process is described below substantially as it is set forth in U.S. patent application Ser. No. 09/655,547 and PCT International Application No. PCT/IB00/01355, both filed Sep. 6, 2000, entitled “METHOD AND APPARATUS FOR EDGE CORRELATION BETWEEN DESIGN OBJECTS”, which are both incorporated herein by reference in their entirety above.

What is more is that the process can be a stand-alone process, or it can be used in conjunction other processes. Other processes can include a user emulation process, which is described with reference to U.S. patent application Ser. No. 09/655,546, and PCT International Application Serial No. PCT/IB00/01356, both filed Sep. 6, 2000, both entitled “USER EMULATION FOR COMPUTER AIDED DESIGN DATA EXCHANGE”, and both of which are incorporated herein by reference in their entirety where permissible under applicable patent law, treaty or agreement. Furthermore, it is noted that in the accompanying figures and description, abstractions of lines and shapes are used, as they might appear to they eye, even though what is actually operated on and used in the techniques are data representations of lines and shapes.

It is useful to describe the edge selection process with reference to a useful, concrete and tangible example. To this end, the edge selection techniques can be considered as a solution to a problem of correlating an edge upon which various CAD operations are performed. For instance, the operations can include a round or chamfer operation on a target CAD model, or selecting a face of an object.

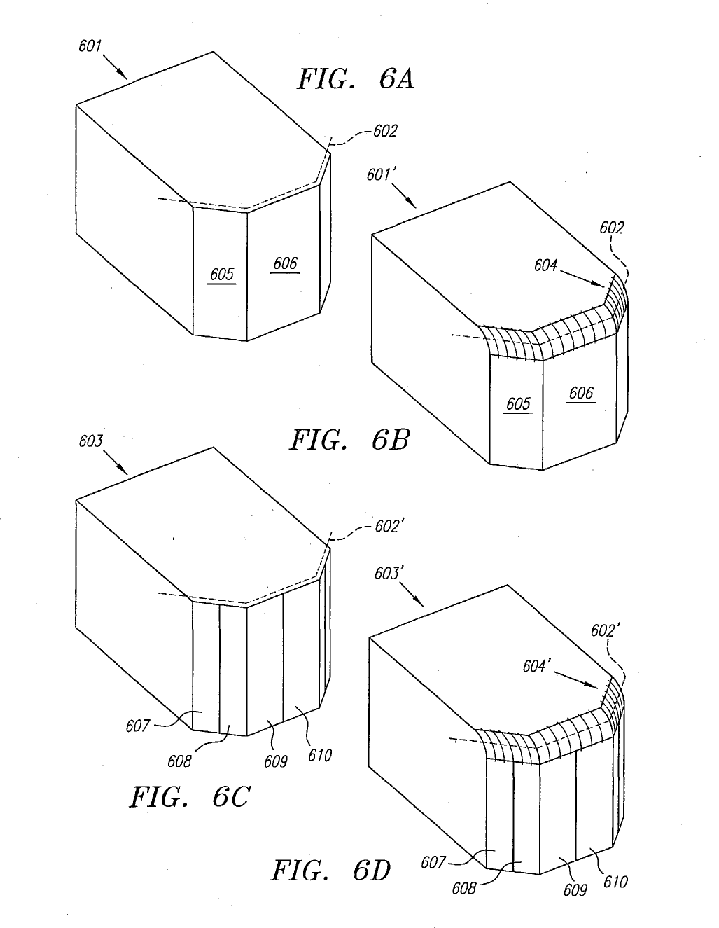

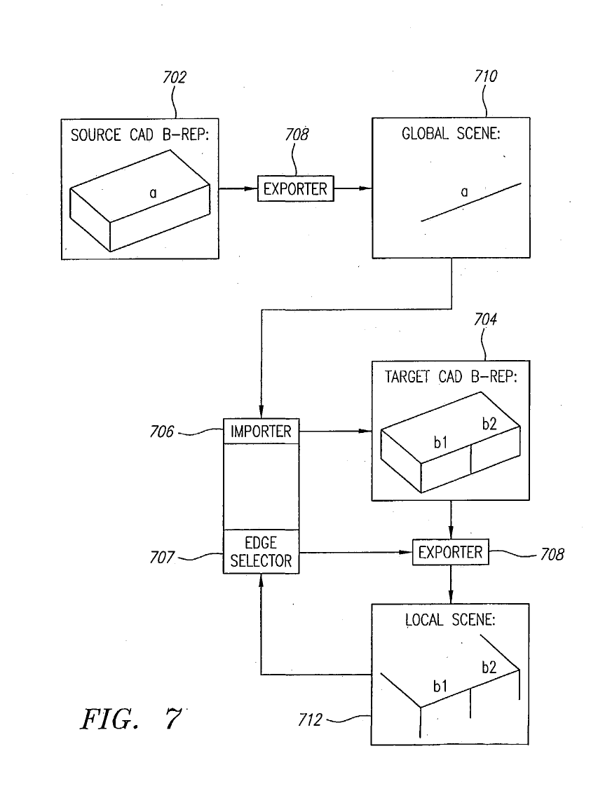

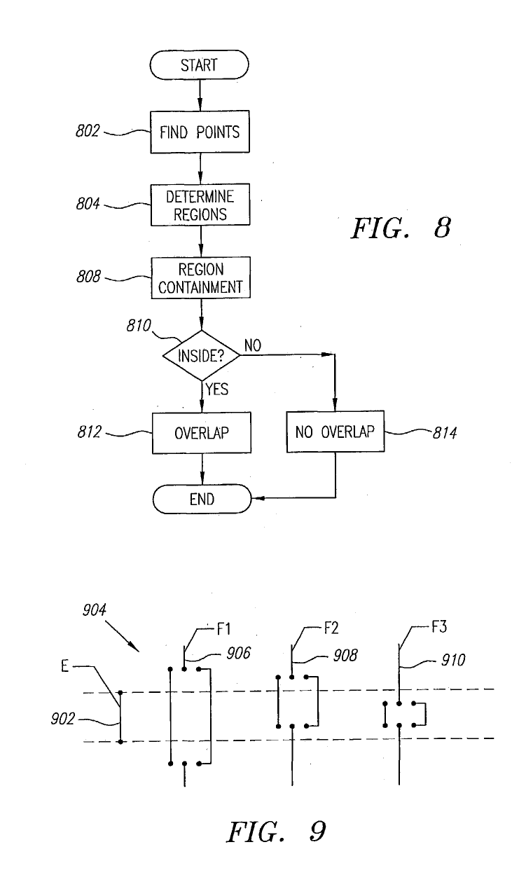

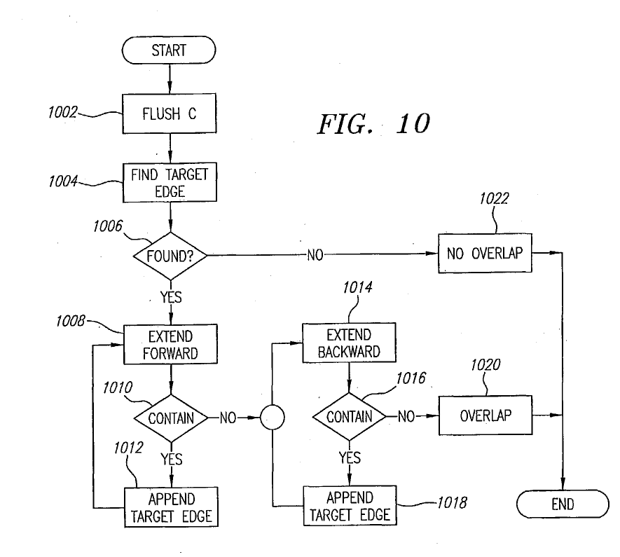

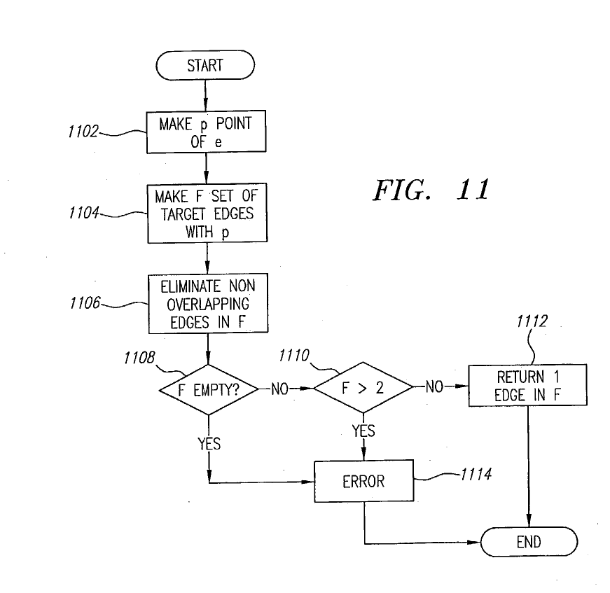

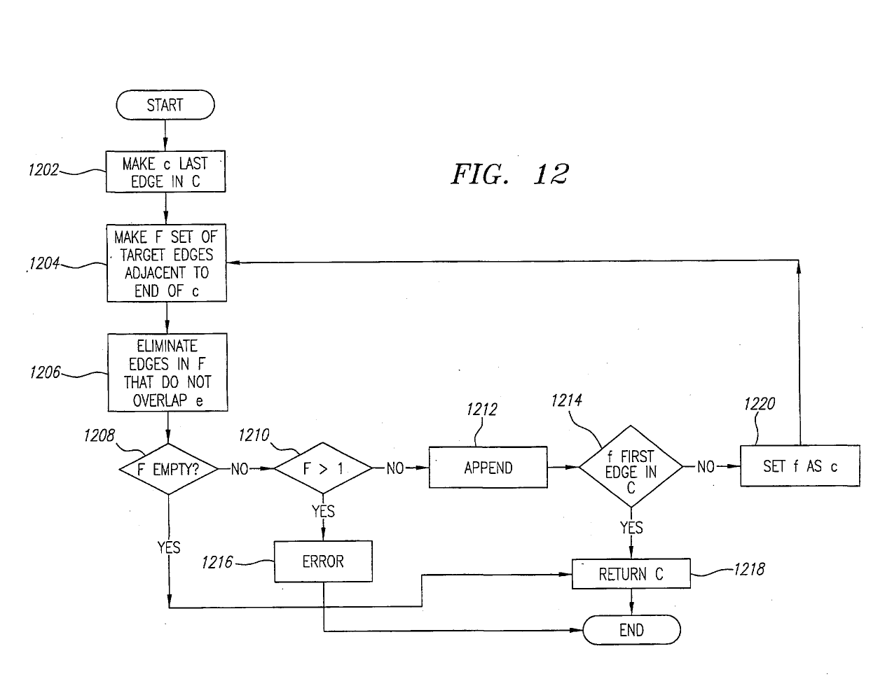

FIGS. 6A-D illustrate the edge correlation problem. FIG. 6A depicts a 3-dimensional object 601 in a source CAD system. The object has a somewhat rounded side that is represented by four faces (only face 605 and 606 are called out). An edge 602 represents a curve formed by the four faces. A round operation is specified in the source CAD model, the operation being performed on the edge 602. Referring to FIG. 6B, when the round operation is performed, a rounded edge 604 is formed where the edge 602 once existed. The object 601 is now shown as object 601′.

As is mentioned above, an underlying object of the CAD data exchange techniques is that the design intent from the source CAD model is preserved in the target CAD model. Accordingly, in some instances finer granularity representations of source CAD model are often found in target CAD models, while in other circumstances, the opposite relationship exists. FIGS. 6C-D show such a finer granularity representation of the source CAD model as embodied in the target CAD system. For instance, in object 603, the four faces that comprise edge 602 in object 601, now consist of eight faces, which include faces 607, 608, 609 and 610, and now make edge 602′. What is desired is to correlate the edge 602 with the edge 602′ so that the feature 604 can be created in the target CAD system as feature 604′.

FIG. 7 depicts an operational overview of the edge selection algorithm. An object (e.g., a boundary representation of a block) exists in the source CAD system 702, the object having an edge “a”. Edge “a” is exported to a global scene 710 for the data exchange product by an exporter module 708. Once the edge “a” has been identified in the global scene 710, the importer module 706 must now identify the corresponding edge in the target CAD system 704. A local scene 712 is then exported from the target CAD system, the local scene representing a plurality of candidate “edges” that may match edge “a”. It is noted here that the local scene 712 is exported in an incremental manner. While it is possible that the entire local scene 712 may be exported at once, generally, this is not the case, which is noted by the circular data flow noted in FIG. 7.

Once the local scene 712 (or a portion thereof) is exported, then the edge selector module 707 begins the correlation process. Edges in the target CAD system 704 that are unnecessary are removed from candidacy, while a mapping is maintained of the others, the mapping ideally representing an n:m, where n is greater than or equal to m, correspondence between the target CAD system 704 edges and the source CAD system 702 edges. Since the mapping is maintained, subsequent operations on edge “a” can be identified as applying to edges “b1” and “b2”. Following are multiple techniques that can be used independently or in combination for selecting an edge.

### Edge Overlap Algorithm

The underlying premise of the edge overlap algorithm is that two edges (i.e., from a source CAD model and a target CAD model—the global and local scene) overlap if their intersection is topologically one dimensional (“1-D”). If the two edges overlap, then they lie on the same geometric carrier.

In one embodiment, the geometry of an edge is represented as a non-uniform rational B-spline (“NURBS”). Making a NURBS representation of the geometry of the edge gives each edge a start-point and an end-point. If the edge is closed (i.e., a circle) then the start-point and end-point coincide. While start-points and end-points are used according to one embodiment, it is also acceptable to use start- and end-vertices. Other embodiments of the invention are envisioned, thus another representation of an edge can also be discrete linear segments with corresponding Cartesian coordinates.

Turning to FIG. 8, it is a flowchart depicting the edge overlap algorithm. In step 802, the start- and end-points of the NURBS representing each edge are extracted from the NURBS.

In step 804, regions are determined in, for instance, the source edge. The regions represent the number of times the source edge is divided if the target edge start- and end-points are mapped onto it. Thus, if a single point in the target edge is found in the source edge, then the source edge has two regions. However, if two points in the target edge are found in the source edge, then the source edge has three regions. It is useful in step 804 to sort the extracted points—the regions of the source edge are between every consecutive pair of distinct (sorted) points.

FIG. 9 illustrates an example of determining regions of a source edge. A source edge “E” (902) and three candidates 904 for target edges “F1” (906), “F2” (908), and “F3” (910) are depicted. Determining the regions of source edge E vis-a-vis the various target edge candidates 904: E has one region with respect to F1; E has two regions with respect to F2; and E has 3 regions with respect to F3. When identifying the regions, it is noted that the source edge always has at least one region but no more than three regions.

Returning to FIG. 8, in step 808, a region containment operation is performed. The region containment algorithm, of which step 808 is a part, assumes that the source edge and the target edge have the same geometric carrier. The region containment operation selects the midpoint of a region defined by the source edge. In step 810, a test is performed to determine whether the selected midpoint is within the target edge. In step 812, if the selected midpoint is within the target edge, then the source and target edges are said to overlap and the result is returned. If the midpoint is not within the target edge, then no overlap is assumed to exist, an appropriate response is returned in step 814.

It is noted that the above process does not require laser-like precision. It is appreciated by the inventors that different CAD systems may represent a non-linear segment in different ways. It is not the objective of the CAD data exchange system to re-create source CAD models exactly the same way in a target CAD model—that is, with the same underlying know-how. Rather, it is the objective to create an acceptable target CAD model that respects the know-how of the source and target CAD systems. Thus, tolerance in determining whether a particular point on the source edge or target edge lies in the other is designed into the analysis. Accordingly, mathematical or statistical analyses can be used to model such a tolerance, or the tolerance can be hard-coded into the CAD data exchange system.

### Edge Containment Algorithm

While the granularity of the target CAD model is ideally the same or finer than the source CAD model, it is possible that the target CAD model represents a particular edge in a manner that is more efficient than the source CAD model. In such a circumstance it is useful to perform an edge containment algorithm (as opposed to the region containment operations) to verify that all of the regions of the source edge are contained in the target edge. It is further noted that this process can be used to verify the overlap of two edges even though the target edge is represented in a finer granularity than the source edge.

As was the case with the edge overlap example, the source and target edges can be utilized from the global and local scenes (depicted in FIG. 7). Depending on the verification desired (i.e., the target edge has more representative regions than the source edge or vice-versa), the input to the edge containment algorithm can be selected according to the desired output. Furthermore, the edge containment algorithm can be used in conjunction with the edge overlap algorithm, which is described above.

Here, for the purpose of explanation, it is assumed that the target edge has more representative regions than the source edge, as was the case above with reference to FIGS. 6A-D. Additionally, when a set of target edges overlap with a source edge “e”, this set of target edges will be referred to as a “connected” set. Furthermore, a sequence of oriented edges, such that the end-point of each oriented edge is the starting point of its successor, will be referred to as a “chain”.

Turning to FIG. 10, it is a flowchart of the edge containment algorithm. In step 1002, a sequence of memory locations representative of a chain of target edges (“C”) is flushed. In step 1004, a first target edge is located, preferably from the local scene, and added to the set “C”. FIG. 11, which is described below, depicts an embodiment of one algorithm for finding the first target edge. According to another embodiment, the system searches for an edge within a given proximity of a source edge “e”.

In step 1006, a test is performed to determine whether a target edge was found and whether the target edge overlaps the source edge “e”. If no target edge was found, or the edges do not overlap, then the target edge is removed from candidacy as a matching edge in step 1022. Otherwise, in step 1008 the target edge is extended forward to encompass a next, connected edge. In step 1010, a test is performed to determine whether the newly extended edge is contained by the source edge “e”. In step 1012, if the newly extended edge is contained by the source edge “e”, then the next, connected edge (extended above) is appended to the target edge and saved in the chain of edges “C”. The process repeats until the target edge can be extended forward no longer.

In step 1014, the same process that was described above with reference to steps 1008-1512 is performed, but here, the target edge is extended backward in steps 1014, 1016, and 1018. Moreover, if the extended edge is not contained by the source edge “e”, then processing continues to step 1020.

It is noted that one embodiment of the edge extension process, which is depicted in steps 1008, 1010 and 1012, as well as steps 1014, 1016, and 1018, is described in below with reference to FIG. 12.

In step 1020, the chain of edges “C” is returned as the target edges that matches the source edge.

### Finding an Initial Edge

Turning to FIG. 11, it depicts an embodiment of a computer implemented method for finding the initial edge for the edge containment algorithm. In step 1102, a point “p” is selected from the source edge “e”. The “p” can be an interior point of “e”, or it can be a start- or end-point. In step 1104, a set of edges “F” (e.g., from the local scene) is created that contains the point “p”. (It is noted that the set of edges “F” may have already existed in the local scene, but additional members of the set “F” can be added at step 1104—since the creation of the local scene is an incremental process.)

In step 1106, non-overlapping edges in set “F” are removed from set “F”. Generally, each edge in set “F” can be iteratively tested against the source edge “e” to verify that the two edges overlap.

In step 1108, a test is performed to determine whether the set “F” is empty. If the set “F” is empty, then an error has occurred, as is indicated in step 1114. If the set “F” is not empty, then in step 1 110 a test is performed to determine whether the set “F” holds more than 2 target edges. If the set “F” holds more than two target edges, then an error has occurred, as is indicated in step 1114. If, however, the set “F” comprises one or two target edges, then one edge is returned for processing in step 1112. (The second edge can be processed if the returned edge does not sufficiently overlap the source edge “e”.)

It is noted that step 1114 can involve one or more error correction schemes whereby the particular error correction scheme selected may have an effect on steps 1108, 1110, and/or 1112. Those schemes can include selecting a new point “p”, or selecting a second point “p′”—the second point “p′” being close to point “p”.

It is noted that FIG. 11 can short circuit the remainder of steps depicted in FIG. 10 if, for instance, a single target edge is identified that completely contains (and is itself completely contained by) the source edge.

### Chain Extension Algorithm

Turning to FIG. 12, it depicts a computer implemented process for extending a chain of edges (“C”) representing the source edge “e” according to an embodiment of the invention. The method can be used as a substitute for the process described above with reference to FIG. 10 (steps 1008, 1010, and 1012, or steps 1014, 1016, and 1018), or an adjunct to the process. Moreover, the chain extension algorithm can be applied equally to the process of extending a chain of edges forward or backward.

In step 1202, a member of the set of edges, i.e., the chain of edges “C”, is made the last edge in the set. For purposes of explanation, this edge will be referred to as edge “c”. In step 1204, a set of target edges adjacent to an end of “c” is identified. This set of adjacent edges will be referred to as set “F”. In step 1206, edges in set “F” that do not overlap the source edge “e” are eliminated—in accordance with any of the overlap or containment processes described above.

In step 1208, a test is performed to determine whether the set “F” is empty. When “F” is empty, then the algorithm proceeds to step 1218. If the set “F” is not empty, then in step 1210 a test is performed to determine whether the set “F” includes more than one target edge. If step 1210 results in a response indicative a set of “F” that is greater than one, then an error has occurred and step 1216 is performed. Step 1216 can include returning a failure result, or indicating that a new edge “c” should be selected, or the existing edge “c” should be extended another direction.

However, if there is exactly one edge adjacent to target edge “c”, then the one edge (edge “f”) is appended to the set “C” in step 1212. In step 1214, edge “f” is tested to determine whether it is the first edge in the set C (i.e., there are no more adjacent edges that are not members of set “C”). If edge “f” is not the first edge in set “C”, then in step 1220, edge “f” is set as edge “c”, and the process continues to step 1204. Otherwise, in step 1218, set “C” is turned and the process is completed.

Finally, it is noted that it may be desired to repeat the above process in another direction—as the process described above was only with reference to a single direction of extension, as indicated in the representative embodiment described above with reference to FIG. 10.

### Face Correlation

Now that a foundation has been laid for CAD data exchange and associated edge selection techniques, we turn to a more detailed explanation of the face correlation methods and systems. We note that the face correlation methods and system described herein are particularly advantageous in a system employing CAD data exchange techniques as described above.

An important initial observation regarding face correlation is that there are at least two types of face correlation, which are distinguished by their usage. The first is “carrier needed”, the second is “face needed”. In the carrier needed type, only the carrier of the face is needed, not the face itself. This is because the faces lies on the carrier surface and can be represented as a surface plus edges, which bound the geometry of the face. However, in the case of face needed, the geometry of the face is needed. The result is that in the carrier needed scenario, once the carrier is identified a number of steps associated with selecting target faces can be eliminated—as compared to the face needed scenario.

We begin with a problem statement: Given a topological entity, e, in the source brep, find a minimal collection of topological entities in the target brep that cover e. While the statement simplifies the problem, it does not address the intricacies of the solution. For instance, there is not always a one-to-one correspondence between topological entities between the source and target breps. For instance, ideally the target brep is a refinement of the source brep. In practice, however, modification of the brep in the target system may be needed, either directly or indirectly, to create the appropriate topological entities.

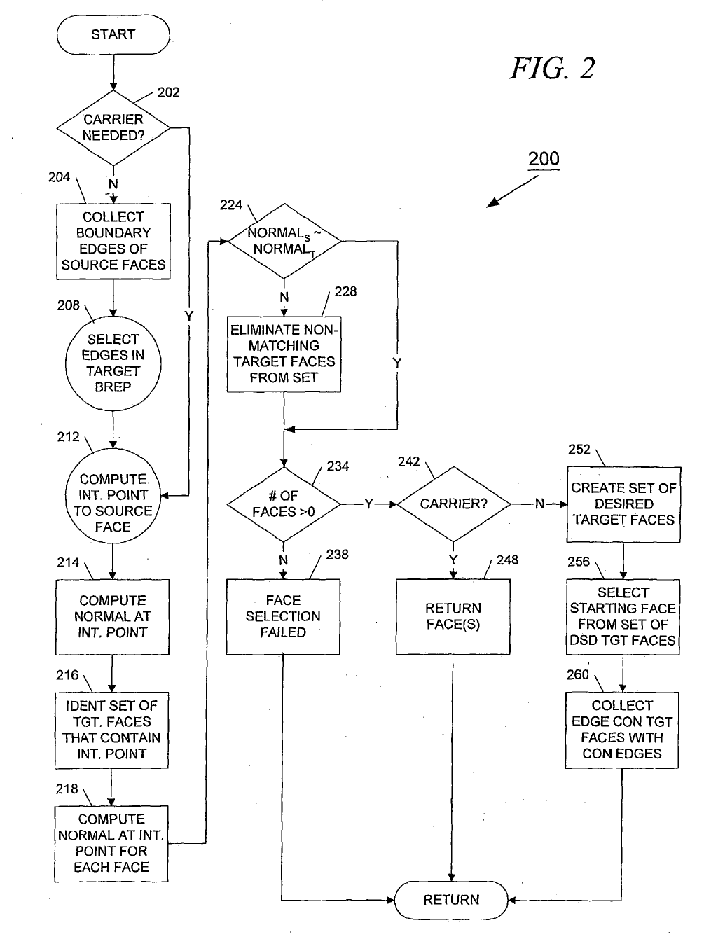

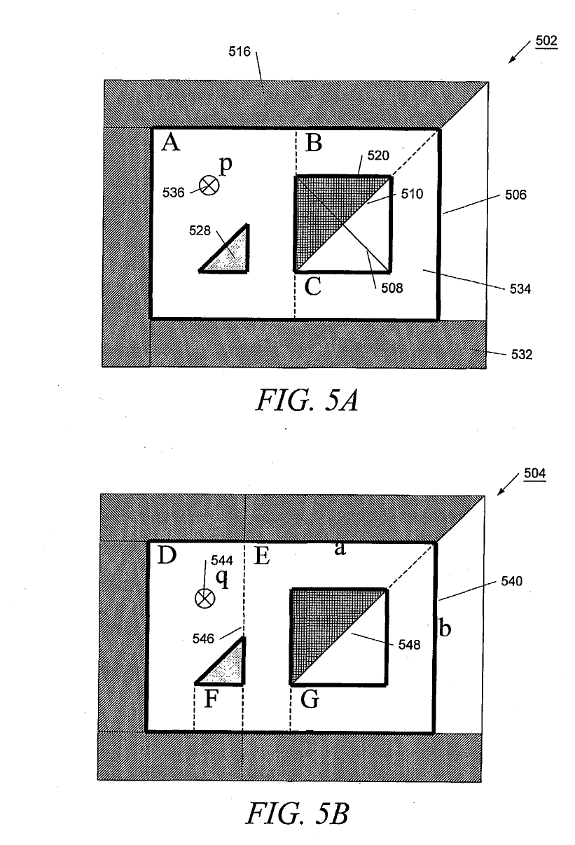

Next, before turning to FIG. 2, which is a flowchart depicting computer implemented steps performed by one or more processors (for example the processors depicted with reference to FIG. 4) for face correlation, we turn to FIGS. 5A-B, which depict representations of CAD data models.

More particularly, FIG. 5A depicts a source data model 502, while FIG. 5B depicts target data model 504 (model 504 is a brep). The various line segments shown in these figures represent edges, of which three types are distinguished. First, the thick lines represent boundary edges 506, the dashed edges are interior edges 512 and 546, and lastly, regular lines represent other edges 508 510, and 548 in the data models.

The fill patterns (e.g., horizontal, vertical, and diagonal lines, as well as the absence of lines) correspond to features 516, 520, 528, 532, and 534. The fill patterns represent symbolic information that may not be available in all data models. Note also that the faces (A, B, C, D, E, F, and G) are called out by capital letters, while edges (a and b) and two points (p and q) are called out by lower case letters.

Returning to FIG. 2, it is again a computer implemented method. The source faces to be selected (for example faces A, B, and C in FIG. 5A) and the target brep 504 are inputs to the techniques. The output will be the target faces that cover the source faces (here, the target faces from FIG. 5B would be D, E, F, and G). Optionally, identification information of the source features that created the source faces can be input, such as the symbolic information represented by the fill patterns.

In step 202, a test is performed to determine whether the current situation is a carrier needed scenario. For instance, a feature that is being correlated between two CAD systems may be a “sketch-on-planar-face operation”, in which case only the carrier of the face as represented in the target CAD system is needed and the system can omit steps 204 and 208. If the scenario is not a carrier needed one, then processing continues to step 204.

In step 204, boundary edges 506 of the faces in source data-model 502 are collected. Next, in step 208, matching boundary edges 540 are selected in the target brep using the edge correlation techniques described above. In step 212, a point that is interior to one of the source faces is computed, preferably using one of the point selection techniques described below. For instance, this point can be point 536, which is also identified as point p.

Next, in step 214 a normal is calculated at the interior point 536. The set of faces in the target data model 504 that contain the interior point 536 (shown here as interior point 544 or q) are then identified in step 216, and in step 218 the normal at the interior point 536 with respect to each constituent of the set of faces identified in step 216 is computed and stored.

In step 224, the target, normals computed in step 218 are compared against the source interior point normal computed in step 214. Here, we are looking to identify any target normals that are not parallel to the source normal. Next, in step 228, all target faces identified in step 216 that do not have a corresponding target normal parallel to the source normal are eliminated.

In step 234, the number of target faces remaining in the set is checked to verify that it is greater than zero. If there are no target faces in the set, then processing continues to step 238, where an error message is generated. If there are more than zero target faces in the set, then in step 242, a test is performed to determine whether the particular face correlation scenario is a carrier needed or other situation. As was mentioned above, this might be true in a “sketch-on-planar-face” operation, where it is sufficient to identify the plan that carries that face, rather than the geometry of the face. Therefore, if the scenario is a “carrier needed” scenario, then processing continues to step 248, where the selected face(s) is returned. As the test was already performed above in step 202, here the test may simply involve checking a status flag set as a consequence of step 202.

However, if the scenario is not a “carrier needed” scenario, then in step 252, a set of desired target faces is created from the non-eliminated faces (this step can be implicit with respect to the process of elimination detailed in step 228 above). In step 256, a starting target face is selected from the set, for instance face D. Next, in step 264, the edge-connected target faces, where the connecting edge is not an edge that was selected in step 208, are collected. These collected faces are returned as the result of the face correlation process.

### Point Selection

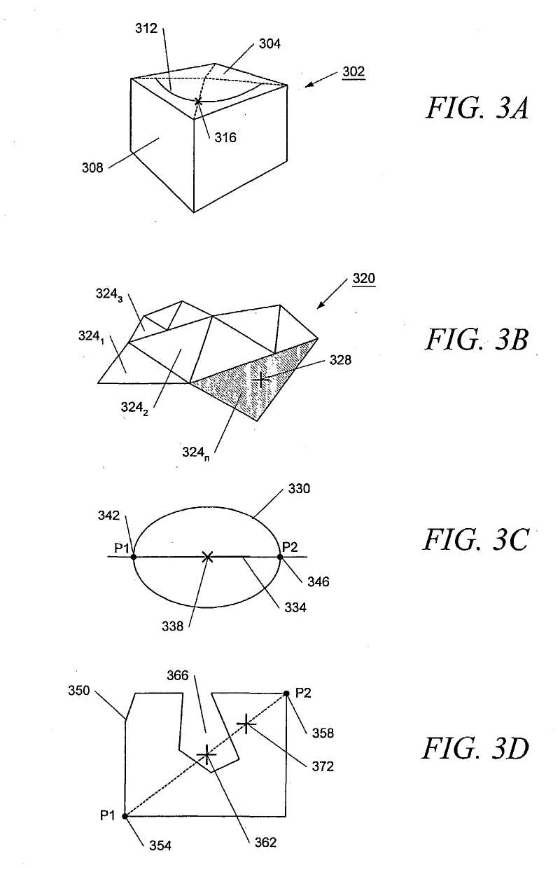

The face correlation algorithm is not dependent upon any particular point selection algorithm and a number of different techniques can be employed to achieve a satisfactory point. As is mentioned above, the API of the source CAD system may be capable of returning a point. However, if an API function is not available, then at least four alternative techniques can be employed. These include the isocurve, random point, triangulation, and line intersection techniques. Where any one technique fails, another can be used as a substitute. Each is described below with reference to a corresponding drawing sheet in FIGS. 3A-D.

### Isocurve

In one embodiment, an isometric curve (“isocurve”) is extracted from the source face. An isocurve is a curve defined by a parametric surface (e.g. S(u,v)), where one of the parameters is constant (e.g. C(t)=S(0.5,t)). FIG. 3A depicts a three dimensional entity 302 comprising a cubic base 308 and pyramid-like, rounded, free-form face 304 overlying the cubic base 308. An isocurve 312 is shown around approximately one-half of the face 304.

The simplest technique for creating an isocurve is to use an API function associated with the source CAD system. However, another technique can involve using the user interface to extract the isocurve. In such an embodiment, the user emulation techniques described in the “CAD DATA EXCHANGE” applications, incorporated herein by reference in their entirety above, can be employed.

As for selecting a point, a point at the midpoint of the isocurve can be used as the interior point. Alternatively, any point along the isocurve can be selected. For example, once isocurve 312 is formed over face 304, a midpoint 316 is computed. The midpoint 316 is designated as the interior point for the face correlation process.

### Triangulation

Still another technique for selecting a point is triangulation. When triangulation is employed, it is generally through an API or other library function of the source CAD system. What triangulation does is geometrically model the face as a set of edge connected triangles. Each triangle can be of a unique size. And the plane on which the surface area of the triangle lies is not necessarily parallel with any other triangles in the set of triangles. FIG. 3B depicts an embodiment of the triangulation technique. Here, a face 320 is modeled as a set of edge connected triangles 324₁₋ₙ.

Once a set of triangles is created, one triangle in the set is selected. For example, the largest triangle is selected. The largest triangle in set 3241-n is triangle 324n. Next, a midpoint 328 of the selected triangle is identified. Next, the midpoint 328 is projected onto the surface of the source face. The point projected onto the surface of the face is used as the interior point.

Note that in some systems, it may first be necessary to extract the geometry of the edges in the parameter space of the surface (t→(u,v)). Furthermore, the triangulation can be performed in two dimensions or three dimensions. If the triangulation is performed in two dimensions, then it should be a done in the parameter space of the face.

### Line Intersection

FIG. 3C graphically depicts the line intersection technique. In this technique, we intersect the face in the uv parameter space with any line. First, we select a face 330 and identify the uv parameter space. Next, a line 334 is selected that intersects the boundary of the face. The line is a parametric line in the uv plane defined by a+b(t), over all real valued t. (Note that “a”, is a point on the line and “b” is a non-zero vector.) The first two intersection points, 342 and 346, are set as points P1 and P2 (for instance, these two points have two minimal parameter values—that is, every point of intersection can be represented by a “t” value on the line and ordered accordingly). Finally, a midpoint 338 between P1 and P2 is chosen as the interior point of the face 330. This midpoint 338 can then be returned to the face correlation algorithm.

### Random Point

In another embodiment, a point in the face is selected by picking a random point in the uv-domain of the surface carrying the face. Each time such a point is selected, the point is tested to determine whether it is, in fact, inside or interior to the face. To this end, a line intersection method, explained above, can be used. However, according to another embodiment, API functions associated with the source CAD system can be used to answer this query.

Turning to FIG. 3D, a face 350 is depicted. Note the cavity 366 in the face 350. A point 362 is randomly selected. When the point 362 is selected, it is tested to determine whether it is interior to the face 350. Point 362 lies in the cavity 366 and is therefore not interior to the face 350. Thus, another point must be selected.

If a point does not lie interior to the face, then another point is randomly selected. But in an alternative embodiment, successive approximations, as measured between the randomly selected point and a point on an edge of the face, can be used to select the next interior point to be tested.

For instance, consider an imaginary line constructed between the randomly selected point 362 and at least one point on an outermost edge of the face 350 (for example, points P1, 354, or P2, 358). Using a successive approximations technique, a next point 372 can be selected that is midway between the randomly selected point 362 and the selected point 358 on the edge of the face 350. Again the new point is tested to determine whether it is interior to the face 350. If the point is interior to the face, then it is returned. If not, then the newly selected point 372 is used with the selected point 358 as the basis for a next point selection that is midway between these two points.

The above techniques are intended to be embodied as one or more sequences of instructions, that is, a computer software or computer program product, that cause one or more processors or technical systems to perform the methods and transformations described herein. The computer software product can comprise executed object instructions and interpreted program code, or various scripting languages.

The computer software product can run on a stand-alone computer, for instance a computer system running Microsoft Windows NT (™), and is an plug-in to an existing computer aided design system, such as ProEngineer 2000i2 (™). However, in other embodiments, the processes can be separated in functionality. For instance, processes associated with the source CAD data model can be performed by a first computer system, while processes associated with the target CAD data model can be performed on a second computer system. Further still, in another embodiment, a middleware system, operating in a server fashion (of a client-server system), can perform the processes either stand-alone (of course, using the APIs on either of two client systems), or as an intermediary between the various processes.

While specific examples and embodiments are described above, it is appreciated that various modifications can be made to these specific embodiments while keeping with the spirit of the invention. For instance, various edge correlation and point selection techniques can be employed.

Furthermore, if a CAD system employs a feature-based naming scheme (for instance as is represented by the various fill patterns shown in FIGS. 5A-B), then symbolic information, as opposed to geometric information, can be used to identify sets of faces. In some cases symbolic information is preferable because it does not need a tolerance to compensate for round-off and other numeric errors. Consequently, rather than using a point-normal technique to select a starting face, as is described above with reference to FIG. 2, the feature-based naming can be employed. For instance, the name and feature of an edge can be material: we might select a face that lies on the same feature (D034) and borders a selected edge that also borders another face from a different feature (D016). Thus edge a is a good choice for a starting face in the target brep, but edge b is not (notice that edge b borders two faces of feature 534). Furthermore, when collecting the remainder of the target faces that cover the source face, the target faces from the appropriate feature are collected—the object is then not crossing edges that lie between two different features (fill patterns).

What is claimed is:

1. A computer implemented method for face correlation in a computer aided design system, comprising:
receiving a data from a source system and a target system, data from the source system including a set of source faces (112) from a source data model, data from the target system including a boundary representation of a target data model (108);
selecting a point (120) in the source data model (104) that is interior to at least one of the source faces (112);
computing a source normal (124) to the interior point (120) with respect to the source face (112);
identifying a set of target faces (132) that contain the interior point (120);
computing a target normal (138) to the interior point (120), computed with respect to a corresponding target face in the set of target faces (132);
determining whether the target normal (138) is parallel to the source normal (124); and
returning the target face (146) corresponding to the target normal (140) if the target normal (140) is parallel to the source normal (124).

2. The method of claim 1, further comprising:
testing to determine whether a carrier is needed, and when a carrier is not needed:
collecting boundary edges of the set of source faces (112); and
correlating the boundary edges to edges in the target boundary representation (108).

3. The method of claim 1 or 2, wherein a carrier is not needed, further comprising:
creating a set of desired target faces (132);
selecting a starting face (146) from the set of desired target faces (132); and
collecting edge connected target faces, where the connecting edge is not an edge correlating boundary edges of the set of source faces to edges in the target boundary representation.

4. The method of claim 1, 2, or 3, wherein selecting the point (120) in the source data model (104) that is interior to at least one of the source faces comprises (112):
extracting an isocurve from the source data model (104), the isocurve corresponding to at least one face in the set of source faces (112);
computing a midpoint of the isocurve; and
returning the midpoint as the interior point (120).

5. The method of claim 1, 2, or 3, wherein selecting a point (120) in the source data model that is interior to at least one of the source faces (112) comprises:
creating a geometric model of the set of source faces (112) as a set of edge connected triangles;
selecting one triangle in the geometric model as a focal triangle;
computing a midpoint of the focal triangle;
projecting the midpoint of the focal triangle onto the surface of the source face; and
returning the projected midpoint of the focal triangle as the interior point (120).

6. The method of claim 1, 2, or 3, wherein selecting a point (120) in the source data model (104) that is interior to at least one of the source faces (112) comprises:
identifying a uv parameter space of a source face in the set of source faces (112);
selecting a line that intersects the boundary of the source face; and
computing a midpoint of the line; and
returning the midpoint as the interior point.

7. The method in any of the above claims, wherein the computer implemented methods are performed in a computer aided design data exchange system configured to import boundary representations on a feature-by-feature basis.

8. The method in any of the above claims, further comprising:
creating a parametric representation (433) of a feature, the feature being extracted and interpreted from a source CAD system in a format other than the feature's native format;
creating an unparameterized representation (453) of the feature, the unparameterized representation of the feature being a boundary representation and supplementing the parametric representation (433) of the feature; and
creating a data dictionary (470) configured to maintain face correlation information that is used to match one or more faces (112) from the source data model (104) to one or more faces (132) in the target data model (108).

9. A computer program product configured to cause one or more processors to perform any of the above claims.

10. A computer aided design system having access to a source data model (104) and a target data model (108), the system configured to correlate faces between the source data model (104) and the target data model (108) and comprising:
a source memory area (105), the source memory area (105) configured to hold information concerning faces (112), edges (116), at least one interior point (120), and an interior point normal (124), all corresponding to the source data model (104);
a target memory area (109), the target memory area (109) configured to hold information concerning edges (128), faces (132), and target normals (136), each target normal (136) matching a face in the target memory area (109), all corresponding to the target data model (108); and
computer program code configured to cause a processor (144) to correlate faces (112) from the source memory area (109) to faces (132) from the target memory area (109), through one or more edges, points, and computations relative to data stored in the respective memory areas.

11. The computer aided design system of claim 10, wherein the processor (144) is configured to perform steps as recited in any of above claims 1-7.
